(19) United States
(12) Patent Application Publication
(10) Pub. No.: US 2025/0053801 A1
(43) Pub. Date: Feb. 13, 2025

(54) MULTI-TASK LEARNING FOR DEPENDENT MULTI-OBJECTIVE OPTIMIZATION FOR RANKING DIGITAL CONTENT

(71) Applicant: Microsoft Technology Licensing, LLC, Redmond, WA (US)

(72) Inventors: Xiaojing Chen, Santa Clara, CA (US); Jiong Zhang, Union City, CA (US); Sen Zhou, Cupertino, CA (US); Zhenjie Zhang, Saratoga, CA (US)

(21) Appl. No.: 18/447,003

(22) Filed: Aug. 9, 2023

(51) Int. Cl. G06N 3/08

(52) U.S. Cl. CPC G06N 3/08

(57) ABSTRACT

Embodiments of the disclosed technologies are capable of providing a ranking of digital content using a machine learning model. The machine learning model is configured for multi-task learning for dependent multi-objective optimization. Embodiments configure a memory according to a machine learning model, where the machine learning model includes a shared backbone and multiple heads. Each of the multiple heads are trained to perform a task associated with a first objective of a second objective.

### TECHNICAL FIELD

Embodiments of the invention relate to the field of multi-task learning; and more specifically, to applications of multi-task learning for multi-objective optimization.

### BACKGROUND

To present digital content items to a user, online systems execute a query, rank the search results returned by the query, and assign the search results to positions based on the ranking. The online system presents the ranked content items in a user interface according to the positions to which the content items are assigned.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for using a hierarchical dependent multi-task machine learning model to rank digital content using components of a computing system that includes an application software system and a user system, in accordance with some embodiments of the present disclosure.

FIG. 2 illustrates an example of a dependency network of user tasks associated with multiple objectives, in accordance with some embodiments of the present disclosure.

FIG. 3 illustrates an example of an architecture of a hierarchical dependent multi-task machine learning model, in accordance with some embodiments of the present disclosure.

FIG. 4 is a flow diagram of an example method for training a multi-headed machine learning model, in accordance with some embodiments of the present disclosure.

FIG. 5 is a flow diagram of an example method for training a head of a multi-headed machine learning model using supervised learning, in accordance with some embodiments of the present disclosure.

FIG. 6 is a block diagram of a computing system that includes a hierarchical dependent multi-task machine learning model in accordance with some embodiments of the present disclosure.

FIG. 7 is an example of an entity graph, in accordance with some embodiments of the present disclosure.

FIG. 8 is a flow diagram of an example method for using a hierarchical dependent multi-task machine learning model, in accordance with some embodiments of the present disclosure.

FIG. 9 is a block diagram of an example computer system including components of an application software system, in accordance with some embodiments of the present disclosure.

### DETAILED DESCRIPTION

Responsive to receiving a search query, a ranking system ranks results of the search query in a rank order according to a ranking score, where the search result with the highest-ranking score is presented as the first item in a list (e.g., at the top of the list) and search results with lower ranking scores are presented further down in the list. The position of an item of a search result in a user interface relative to other items of the search result often corresponds to the ranking score of the item. Examples of search results include digital content items, such as documents, videos, audio files, digital images, and web pages, such as entity profile pages.

In an embodiment, at least some portions of a content ranking process are performed by a machine learning model. The machine learning model uses a “learning-to-rank” algorithm to learn a function that assigns a score to one or more items of a search result (e.g., the content responsive to the search query). Learning-to-rank approaches apply supervised machine learning to solve ranking problems. Examples of learning-to-rank techniques include pointwise methods, pairwise methods, and listwise methods.

Listwise learning-to-rank techniques rank items in a list based on a permutation of items and not based on the score that each item received. That is, with listwise learning-to-rank, the list of items retrieved in a search result is treated as a single unit. For example, given an input of a list of items A, B, C and a search query, an output of a model executing listwise ranking is a ranking of the list of items ABC, e.g., a ranking score that reflects the relevance of the entire list A, B, C to the search query. In contrast, pointwise learning-to-rank ranks items based on a score associated with each entry to be ranked. That is, with pointwise learning-to-rank, each item to be ranked is scored independently. For example, given the input of A, B, C and a search query, an output of a model executing pointwise ranking is a score of A (85% relevant to a search query), B (50% relevant to the search query) and C (20% relevant to the search query). In pairwise learning-to-rank, pairs of neighboring entries are ranked according to a score associated with pairs of entries. For example, given the input of A, B, C and a search query, an output of a model executing pairwise ranking is score of pairs of inputs (e.g., A is 85% more relevant to the search query than B. B is 30% more relevant to the search query than C, etc.) Thus, whereas pointwise learning-to-rank computes a score for each individual item to be ranked (where the items are ranked based on the individual scores) and pairwise learning-to-rank computes a score for each pair of items to be ranked (where the pairs are ranked based on the scores computed for the pairs), listwise learning-to-rank computes a score for each list of items to be ranked (where the lists are ranked based on the scores computed for the lists).

In each of these learning-to-rank algorithms, the inputs to a machine learning model are search results represented as feature vectors. However, the rankings produced by the machine learning models executing different learning-to-rank algorithms may differ even for the same input. For example, as described above, the output of a machine learning model trained using a listwise learning-to-rank approach includes a relative ranking score that maintains a specific permutation of the items in the list (e.g., a ranked list), while the output of a machine learning model trained using a pointwise learning-to-rank algorithms includes absolute relevance scores which can be interpreted as probabilities for each item in the list. For example, the output of a machine learning model trained using listwise learning-to-rank is a three-dimensional tensor with dimensions such as (batch size, list size, feature size), where the batch size represents the number of training samples in a training batch, the list size represents the number of items to be ranked in a list, and the feature size represents a number of features extracted from the items to be ranked. In contrast, the output of a machine learning model trained using pointwise learning-to-rank is a two-dimensional tensor with dimensions such as (batch size, feature size). A machine learning model that has been trained using a learning-to-rank algorithm may be referred to herein as a ranking machine learning model or ranking model.

These differences in outputs of the differently-trained ranking machine learning models (e.g., ranking machine learning models trained to perform pointwise ranking to compute a probability score of items versus ranking machine leaning models trained to perform listwise ranking to compute a list of items) can create complications when the output of the ranking machine learning model is to be used as an input to another machine learning model. For example, some machine learning models are better equipped to receive, as an input, an absolute probability score rather than a relative ranking score without a probability interpretation (e.g., a list). As a result, conventional ranking machine learning models have been trained to perform pointwise leaning-to-rank and not listwise learning-to-rank.

Embodiments are described herein with respect to an example use case in which a first user and a second user of an online system have different objectives for their use of the online system, where it would be desirable for a ranking model to balance both the first user's objective and the second user's objective when ranking content items.

An example of a first user is a searcher (e.g., a seller user) whose objective of using the online system includes searching for users of the online system who are likely to be interested in or want to “buy” a product or an opportunity, such as a job opening. The searcher user's search query could include, for example, a request for the online system to retrieve and display a list of user profiles that match a particular criterion (e.g., job title, skills, years of experience). The searcher user interacts with the search results by, for example, clicking on a second user's profile, sending a message to the second user, and/or saving the second user's profile.

As used herein, the second user may be referred to as a recipient (e.g., a buyer user). The recipient user can interact with the searcher user by, for example, opening and/or accepting a message from the searcher user, and/or responding to a message from the searcher user.

Using the above-described terminology only for ease of discussion and not to limit the scope of the claims, the recipient users and the searcher users may be any users of the online system whose objectives of using the online system are considered to be contradicting. As used herein, contradicting objectives may refer to opposing goals, such as a goal to perform “X” and a goal to perform “not X”, where X may refer to a specific activity or purpose for which the online system may be used.

For example, an objective of the searcher user may include interacting with as many items of a search result as possible (e.g., sending exploratory emails to as many recipient users as possible to maximize the likelihood of eliciting engagement from as many recipient users as possible). In contrast, an objective of the recipient user may include conserving resources (including computing resources such as power, bandwidth, memory, and time) spent engaging with irrelevant content (e.g., to minimize the number of emails that the recipient user needs to review, accept, and/or open).

The technologies described herein are capable of balancing the optimization of multiple competing or contradictory objectives, such as the recipient and searcher objectives described above, when the competing or contradictory objectives are related. Further, each objective is modeled using one or more modeling tasks. As described herein, modeling tasks describe a task learned by a machine learning model, and user tasks describe tasks performed by a user. The modeling tasks learn to model a relevant score related to a particular user task. Accordingly, the disclosed technologies are capable of providing multi-task multi-objective ranking even when the objectives are contradicting and one of the modeling tasks associated with an objective is dependent upon another modeling task associated with the other objective. These and other examples described herein are used for illustration purposes and ease of discussion only and not to limit the scope of any of the claims.

In some conventional systems, multi-objective optimization problems are solved using multiple independently trained machine learning models. For example, a first machine learning model is trained to optimize the recipient user's objective and a second machine learning model is trained, separately from the first machine learning model, to optimize the searcher user's objective, respectively. For instance, in a conventional approach, a first machine learning model optimizes the searcher user's engagement (the searcher's objective) by ranking search results according to likelihood of searcher engagement. Conventional systems optimized only for the searcher's objective can be very demanding in terms of consumption of computing resources such as bandwidth, power, memory, and network traffic, because, for example, the conventional system is optimized to send communications (such as messages) to every relevant recipient included in the search result (even if the relevant recipient is unlikely to interact with and/or open a message).

The likelihood of searcher engagement can be modeled using one or more user tasks (e.g., user actions performed using the online system) that are related to searcher engagement. Examples of such user tasks include viewing a recipient profile, adding a recipient profile to a list of recipient profiles, sending a message to a recipient, and/or saving a recipient profile.

In the conventional approach, a second machine learning model optimizes the recipient satisfaction by ranking the recipients according to a likelihood of the recipient accepting an interaction from the searcher (e.g., responding to a searcher email). Conventional systems optimized only for the recipient's objective tend to be overly restrictive in that they identify only those users who are likely to engage with the searcher, whether or not those users are relevant to the searcher's search criteria.

As used herein, a user task may refer to an online activity that is related to or indicative of a particular objective. For example, user tasks performed by a searcher user, such as viewing a recipient profile, sending a message to a recipient, or storing a recipient profile in a list, are related to the searcher's objective of increasing searcher engagement. As another example, user tasks performed by a recipient user, such as viewing a message from the searcher user or accepting an interaction from the searcher user, are related to the recipient's objectives of conserving computing resources and minimizing unwanted messages such as spam.

In such conventional systems, executing two independent machine learning models that each optimize a different objective modeling one or more modeling tasks does not model the dependency relationships between the modeling tasks of the objectives. As used herein, a modeling task may refer to a process performed by a machine learning model or by a portion of a machine learning model (such as a head), which generates an output that is optimized according to one or more objectives related to one or more user tasks. For example, some conventional systems algorithmically combine the results from each of the multiple independent machine learning models described above to try to obtain a ranking result that balances the recipient's objective and the searcher's objective. Additionally, some conventional systems manually determine one or more hyperparameters used to algorithmically combine the recipient's objective and the searcher's objective to obtain a balanced multi-objective ranking. In contrast, as described in more detail below, embodiments of the disclosed technologies do not manually tune the outputs of the models but instead use a single model that machine-learns the optimal tuning.

Aspects of the present disclosure address the above and other deficiencies by modeling the complicated relationship of multiple dependent modeling tasks associated with contradicting objectives. Embodiments described herein optimize for multiple contradicting objectives by organizing different modeling tasks in different levels of a multi-headed machine learning architecture. As a result, in contrast to prior approaches, the machine learning system described herein can, for example, appropriately rank a list of recipient users that are likely to interact with a searcher user, where the list of recipient users are also relevant to the searcher's search query.

Conventional multi-headed machine learning assumes that each of the task-specific portions of the machine learning model (e.g., heads of the multi-headed machine learning model learning a modeling task) learn similar and/or related tasks. When the modeling tasks or objectives of the multi-headed machine learning model differ (e.g., are contradicting), negative transfer learning occurs. Negative transfer learning is when the performance of a first head improves while the performance of a second head degrades. This results from, for example, the first head learning to optimize a first modeling task. The first head learns the first modeling task by optimizing an error function such that the error, determined by comparing the predicted first modeling task to a ground truth, decreases over time. In practice, the error decreases over time because the error is propagated through the multi-headed machine learning model such that a shared portion of the multi-headed machine learning model adjusts. However, the adjustment of the shared portion of the multi-headed machine learning model can negatively affect the other portions of the multi-headed machine learning model. For instance, the second head does not learn to optimize the second modeling task as a result of the adjustments to the shared portion of the multi-headed machine learning model based on the error associated with the first head learning the first modeling task. Accordingly, conventional multi-headed machine learning have been considered unsuitable for applications in which the modeling tasks or objectives are contradictory.

In embodiments of the disclosed machine learning model architecture, multiple modeling tasks learn user tasks (online activities that are related to or indicative of a particular objective). The modeling tasks are arranged in a hierarchically dependent way, which allows a single machine learning model to share information across the different modeling tasks in the different levels of the machine learning model while also learning the dependency relationship of modeling tasks. The hierarchical dependent arrangement of the heads of the disclosed multi-headed machine learning model counters the detrimental effects of negative transfer learning. Additionally, embodiments of the machine learning model architecture described herein incorporate listwise ranking to help maximize accuracy of the ranked results for the multi-objective ranking problem.

Certain aspects of the disclosed technologies are described in the context of ranking search results with respect to a pair of objectives, e.g., a first user objective and a second user objective, such as a recipient user objective and a searcher user objective, using a machine learning model. Aspects of the disclosed technologies can be used to rank any type of digital content item, including results of searches for any type of entity, organization, user or account.

The disclosure will be understood more fully from the detailed description given below, which references the accompanying drawings. The detailed description of the drawings is for explanation and understanding, and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains, but can be used with or incorporated into other embodiments, including embodiments shown in other drawings.

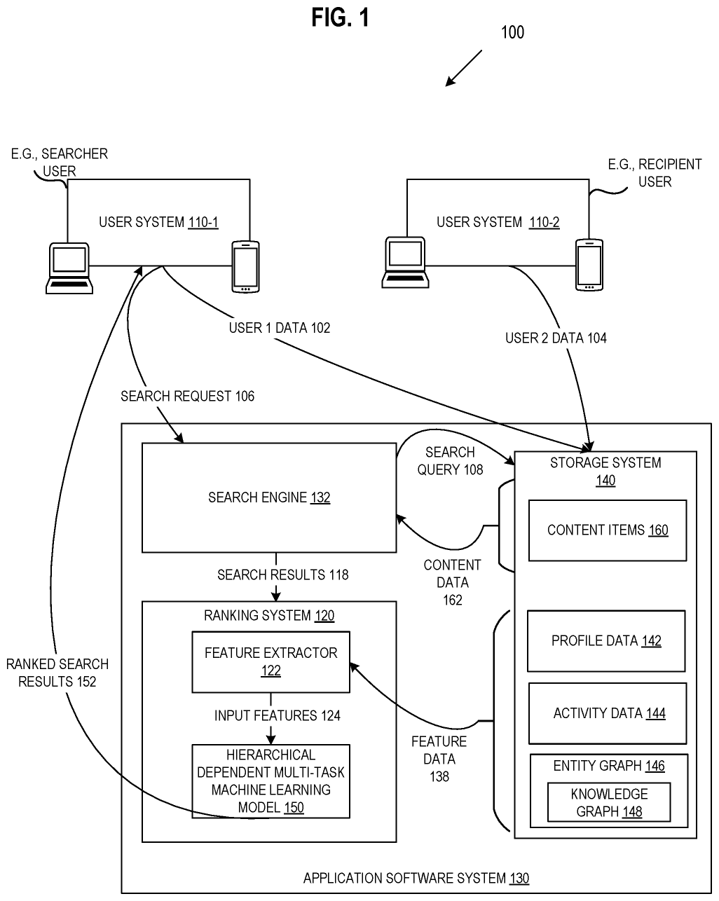

FIG. 1 is a flow diagram of an example method for using a hierarchical dependent multi-task machine learning model to rank digital content using components of a computing system that includes an application software system and a user system, in accordance with some embodiments of the present disclosure.

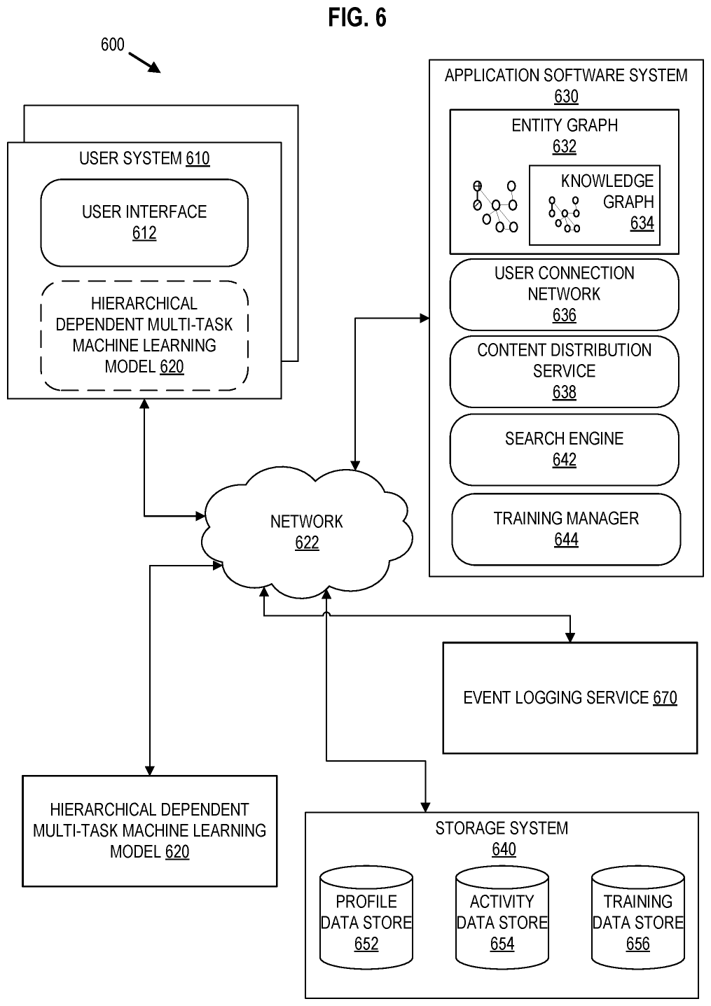

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of the ranking system 120, including, in some embodiments, components shown in FIG. 1 that may not be specifically shown in FIG. 6, or by the hierarchical dependent multi-task machine learning model 620 of FIG. 6, including, in some embodiments, components shown in FIG. 6 that may not be specifically shown in FIG. 1, or by components shown in any of the figures that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, in the example computing system 100, an example application software system 130 is shown, which includes a ranking system 120, a storage system 140, and a search engine 132. The ranking system 120 of FIG. 1 includes a hierarchical dependent multi-task machine learning model 150 as described with reference to FIG. 6, and a feature extractor 122. In the example of FIG. 1, the components of the application software system 130 are implemented using an application server or server cluster. In other implementations, one or more components of the application software system 130 are implemented on a client device, such as a user system 610, described herein with reference to FIG. 6. For example, some or all of application software system 130 is implemented directly on the user's client device in some implementations, thereby avoiding the need to communicate with servers over a network such as the Internet. In yet other implementations, the components of the ranking system 120 are executed as an application or service, executed remotely or locally.

As described in more detail below, ranking system 120 ranks search results to provide a balanced ranking of search results with respect to two contradicting objectives, and provides the ranked search results to, for example, user system 110-1. While FIG. 1 shows that ranked search results 152 are provided to user system 110-1, it should be appreciated that the ranked search results 152 can be provided to alternate systems, e.g., for subsequent processing.

The ranking system 120 includes a feature extractor 122 that converts a list of search results 118 into one or more features input to the hierarchical dependent multi-task machine learning model 150. In some embodiments, the feature extractor 122 also converts profile data 142, activity data 144, entity graph 146 and/or knowledge graph 148 into one or more features input to the hierarchical dependent multi-task machine learning model 150.

The ranking system 120 also includes a hierarchical dependent multi-task machine learning model 150 that leverages known user task-dependent relationships and facilitates knowledge sharing among modeling task-specific portions (e.g., heads) of the machine learning model. The hierarchical dependent multi-task machine learning model 150 uses a multi-task learning framework to machine-learn each of the modeling tasks associated with performing an optimization of a particular objective.

As shown, the storage system 140 stores different data associated with user system 110-1 and/or user system 110-2 (referred collectively as user systems 110). In some embodiments, every time the user system 110 interacts with one or more applications of the application software system 130 (e.g., such as search engine 132), the storage system 140 logs and/or stores the user interaction. A user of the user system 110 interacts with applications, services, and/or content presented to the user. Examples of data that can be stored at storage system 140 include user 1 data 102 and user 2 data 104 including content items 160, profile data 142, activity data 144, entity graph 146, and/or knowledge graph 148.

In some embodiments, the storage system 140 stored content items 160 including users registered to the application software system 130, articles posted or uploaded to the application software system 130, and products offered by the application software system 130. The content items 160 include any digital content that can be displayed using the application software system 130.

In some embodiments, when a user interacts with an application of the application software system 130 (e.g., via user 1 data 102 and/or user 2 data 104), the user may provide personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. Some or all of such information can be stored as profile data 142. Profile data 142 may also include profile data of various organizations/entities (e.g., companies, schools, etc.).

In some embodiments, when a user interacts with an application of the application software system 130 (e.g., via user 1 data 102 and/or user 2 data 104), the application software system 130 logs the user's interactions. For example, as described with reference to FIG. 6, the application software system 130 may include an event logging service 670. The logged activity is stored as activity data 144. The activity data 144 can include content viewed, links or buttons selected, messages responded to, etc.

In some embodiments, when a user interacts with an application of the application software system 130 (e.g., via user 1 data 102 and/or user 2 data 104), the user engages with one or more other users of the application software system 130 and/or content provided by the application software system 130. As a result, an entity graph 146 is created which represents entities, such as users, organizations (e.g., companies, schools, institutions), and content items (e.g., user profiles, job postings, announcements, articles, comments, and shares), as nodes of a graph. Entity graph 146 represents relationships, also referred to as mappings or links, between or among entities as edges, or combinations of edges, between the nodes of the graph. In some implementations, mappings between or among different pieces of data are represented by one or more entity graphs (e.g., relationships between different users, between users and content items, or relationships between job postings, skills, and job titles). In some implementations, the edges, mappings, or links of the entity graph 146 indicate online interactions or activities relating to the entities connected by the edges, mappings, or links. For example, if a user views and accepts a message from another user, an edge may be created connecting the message-receiving user entity with the message-sending user entity in the entity graph, where the edge may be tagged with a label such as “accepted.”

Portions of entity graph 146 can be automatically re-generated or updated from time to time based on changes and updates to the stored data, e.g., in response to updates to entity data and/or activity data from a user. Also, entity graph 146 can refer to an entire system-wide entity graph or to only a portion of a system-wide graph, such as a sub-graph. For instance, entity graph 146 can refer to a sub-graph of a system-wide graph, where the sub-graph pertains to a particular entity or entity type.

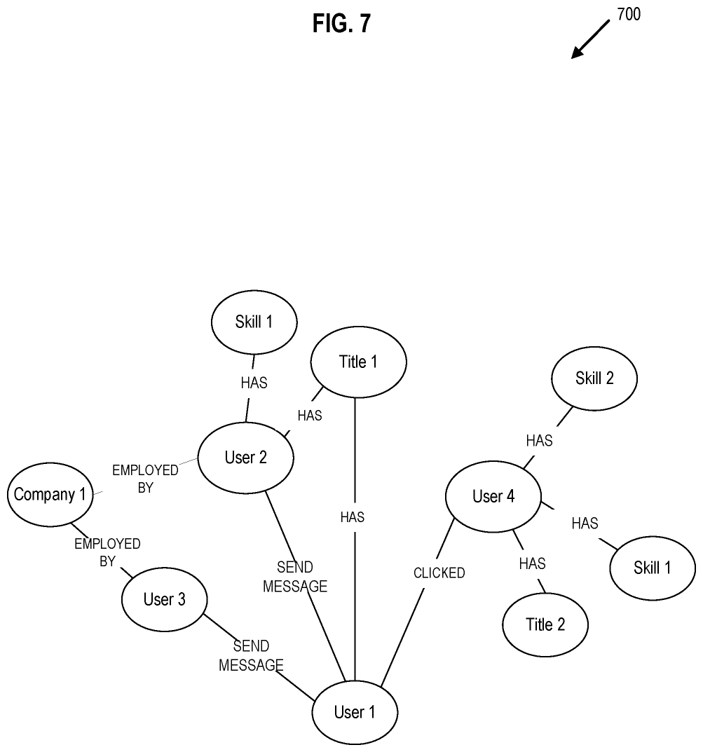

Not all implementations have a knowledge graph, but in some implementations, knowledge graph 148 is a subset of entity graph 146 or a superset of entity graph 146 that also contains nodes and edges arranged in a similar manner as entity graph 146, and provides similar functionality as entity graph 146. For example, in some implementations, knowledge graph 148 includes multiple different entity graphs 146 that are joined by cross-application or cross-domain edges or links. For instance, knowledge graph 148 can join entity graphs 146 that have been created across multiple different databases or across multiple different software products. As an example, knowledge graph 148 can include links between content items that are stored and managed by a first application software system and related content items that are stored and managed by a second application software system different from the first application software system. Additional or alternative examples of entity graphs and knowledge graphs are shown in FIG. 6 and FIG. 7, described below.

As shown in the example of FIG. 1, in operation, the search engine 132 receives a search request 106 from a user system such as user system 110-1. The search engine communicates a search query 108 to the storage system 140 to retrieve content data 162 from stored content items 160 relevant to the search query. In an example, the search engine 132 receives a search request 106 from a user system 110-1 (e.g., a searcher) for a list of potential recipients (e.g., users of user system 110-2). The search engine 132 includes, for example, a software system designed to search for and retrieve information by executing queries on content items 160 stored in the storage system 140. The search query 108 is designed to find information that matches specified criteria, such as keywords and phrases of the search request 106. As a result of the search query 108, the search engine 132 receives content data 162 from the storage system 140. In some embodiments, the search engine 132 communicates a search query 108 to one or more external systems or databases to retrieve content data 162. For example, the search engine 132 crawls digital content (e.g., websites) for content data 162 associated with the search query 108. Alternatively or additionally, in some embodiments, the search engine 132 retrieves data from other sources, such as profile data 142, activity data 144, entity graph 146 and/or knowledge graph 148, and/or uses any of such other sources to identify and retrieve content data 162.

The search engine 132 produces content items (e.g., search results 118) based on the content data 162 that include information related to the search request 106, and provides the items, e.g., search results 118, to the ranking system 120. The ranking system 120 includes one or more models, such as the hierarchical dependent multi-task machine learning model 150, which are configured to rank the search results 118 and determine an order of the search results 118 to return to the user system 110-1 as ranked search results 152.

In some embodiments, the feature extractor 122 determines input features 124 associated with the search results 118 and profile data 142, activity data 144, entity graph 146, and/or knowledge graph 148 (collectively referred to herein as feature data 138 utilized by the feature extractor 122). In some embodiments, the feature extractor 122 can extract features directly from the feature data 138 (e.g., without processing or converting the data). For example, the feature extractor 122 can create a feature vector representing a preference or characteristic of a user by extracting information from the profile data 142 and/or activity data 144. In some embodiments, the feature extractor 122 analyzes the search results 118 with respect to the feature data 138 to determine one or more features. For instance, the feature extractor 122 parses through the search results 118 and activity data 144, and/or entity graph 146/knowledge graph 148 data to determine a number of times a first user (e.g., the recipient operating user system 110-2) received a communication from a second user (e.g., the searcher operating user system 110-1) to which the first user (e.g., the recipient) responded. The feature extractor 122 subsequently creates a feature vector representing the number of times the first user (e.g., the recipient user) has responded to a communication from a second user (e.g., the searcher user). In some embodiments, the feature extractor 122 parses through the search results 118 and profile data 142 to determine a number of users of the search result associated with a particular job title, skill, or company. Accordingly, the feature extractor 122 uses the profile data 142, activity data 144, entity graph 146 and/or knowledge graph 148 (e.g., feature data 138) in combination with the search results 118 to extract input features 124 for the hierarchical dependent multi-task machine learning model.

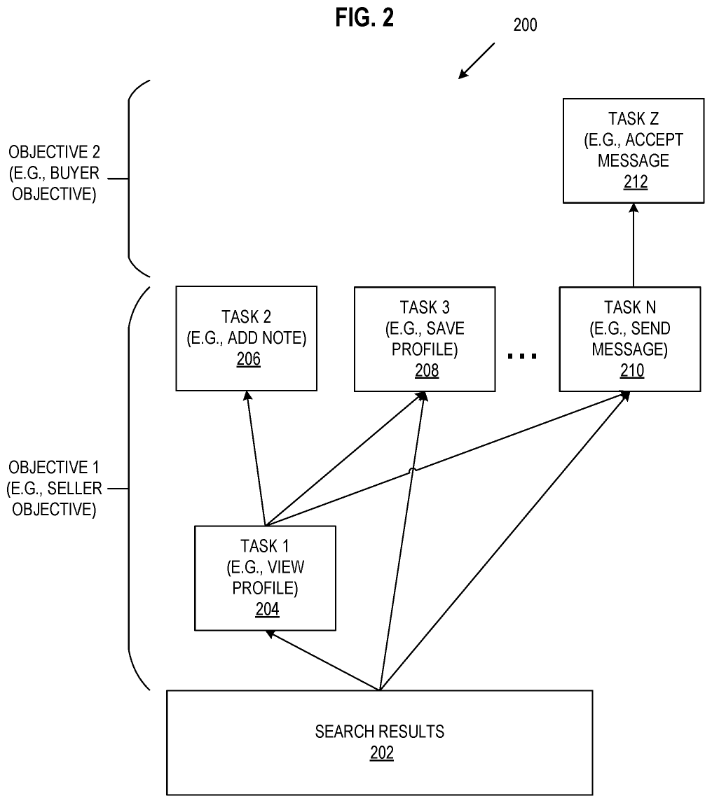

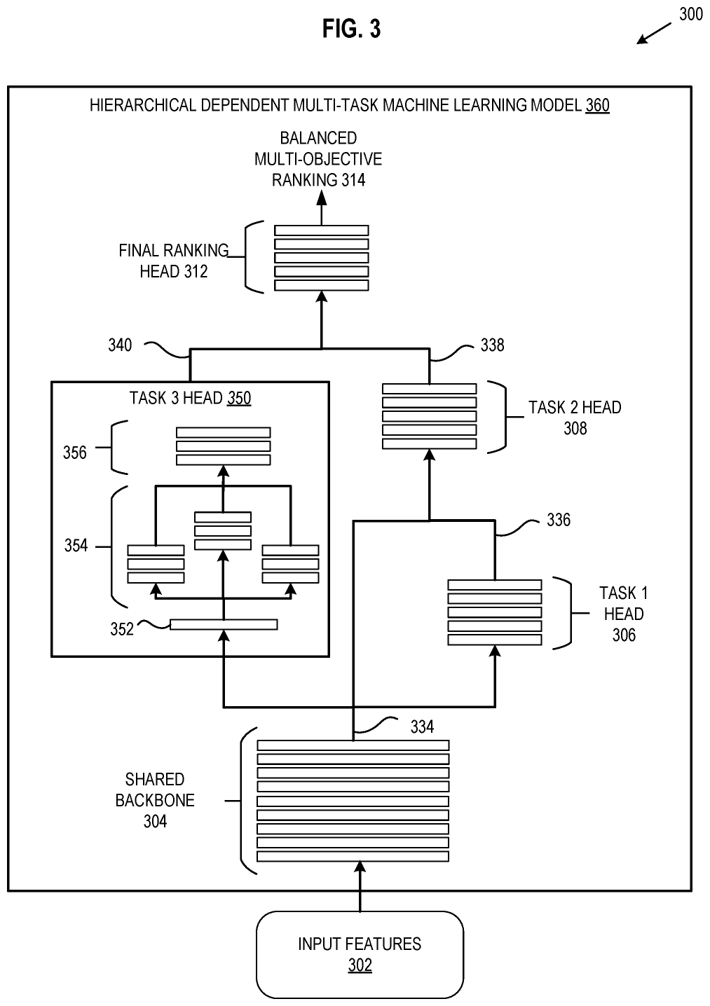

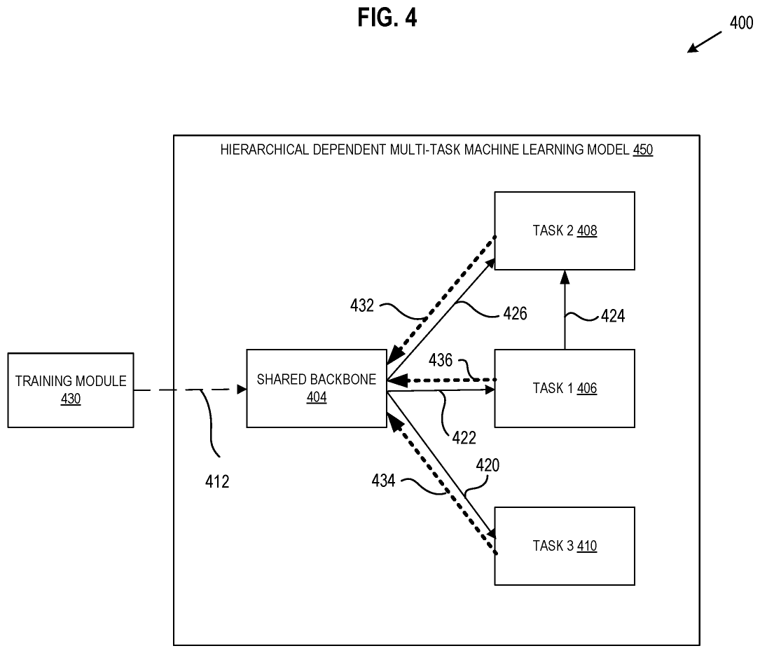

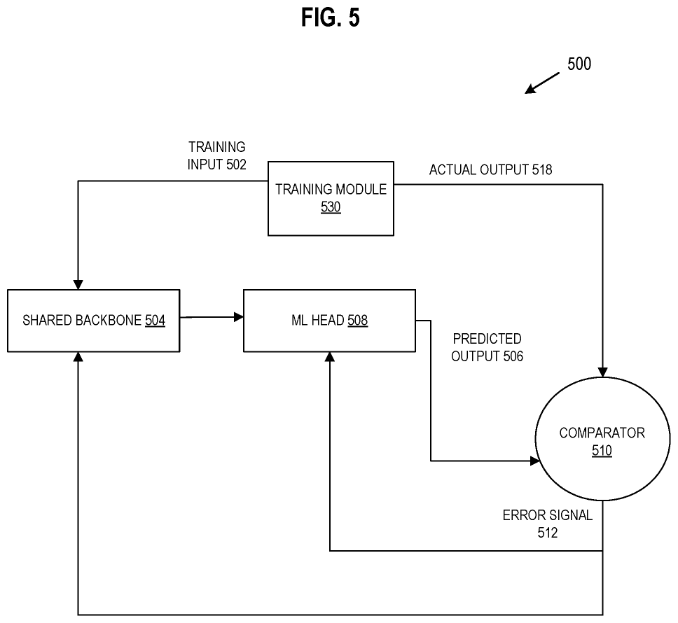

As described in more detail with reference to FIG. 3, the hierarchical dependent multi-task machine learning model 150 leverages known user task-dependent relationships and facilitates knowledge sharing among modeling task-specific portions (e.g., heads) of the machine learning model. As described with reference to FIG. 2, each objective of the multi-objective machine learning model may be associated with one or more modeling tasks. The hierarchical dependent multi-task machine learning model 150 uses a multi-task learning framework to machine-learn each of the modeling tasks associated with performing an optimization of a particular objective. Training the heads of the hierarchical dependent multi-task machine learning model 150 is described with reference to FIGS. 4 and 5.

The hierarchical dependent multi-task machine learning model 150 uses a backbone (example shown in FIG. 3) to share the same set of features across one or more heads of the hierarchical dependent multi-task machine learning model 150. Although the objectives of different task-specific heads are contradicting, each head of the hierarchical dependent multi-task machine learning model 150 benefits by sharing the same set of features. This type of cross-task information sharing is especially useful when the data distribution for each objective is skewed. For example, a skewed data distribution can occur when the data associated with performing the searcher objective (e.g., the data associated with the searcher engaging with the recipient, where the searcher engaging with the recipient includes viewing the recipient profile, adding a note to the recipient profile, sending a message to the recipient profile, saving the recipient profile to a list, etc.) is larger than the data associated with performing the recipient objective (e.g., the data associated with the recipient accepting the searcher interaction/engagement).

The hierarchical dependent multi-task machine learning model 150 balances optimization of both the searcher objective and recipient objective to produce ranked search results 152. In one embodiment, the ranked search results 152 represent one or more retrieved items that are related to the search request 106 associated with the searcher objective, and one or more retrieved items that are likely to result in a recipient interaction with the searcher in response to a communication from the searcher to the recipient.

The examples shown in FIG. 1 and the accompanying description above are provided for illustration purposes. This disclosure is not limited to the described examples. Additional or alternative details and implementations are described herein.

FIG. 2 illustrates an example of a dependency network of user tasks associated with multiple objectives, in accordance with some embodiments of the present disclosure.

Using the example terminology described herein, a first objective may be referred to as a searcher objective that includes engaging with as many relevant recipients as possible, where relevant recipients are identified according to the search results 202. The objective of engaging with searchers can include, for example, any type of user task such as task 1 204 (e.g., viewing a recipient profile by clicking on the recipient profile), task 2 206 (e.g., adding a note to a recipient profile), task 3 208 (e.g., saving the recipient profile in a list of recipient profiles), task N 210 (e.g., sending an email to the recipient profile). As shown in the dependency network 200, some user tasks are dependent upon a sequence of user tasks. For example, a searcher can only add a note to a recipient profile (e.g., task 2 206) responsive to viewing the recipient profile (e.g., task 1 204). Also shown in the dependency network 200, some user tasks are not dependent upon a sequence. For example, a searcher can send a message to a recipient (e.g., task N 210) without clicking on the recipient profile (e.g., task 1 204).

A second objective may be referred to as a recipient objective that includes limiting interactions to relevant communications (e.g., communications from searchers that are of interest to the recipient), such as limiting the recipient's viewing or acceptance of communications from the searcher to only relevant searchers such that the likelihood of the recipient accepting and/or interacting with non-relevant interactions from searchers is minimized. As shown in the dependency network 200, a recipient objective (e.g., task Z 212) is dependent on a user task performed by the searcher (e.g., task N 210). As shown, some objectives (like the searcher objective) are associated with performing many user tasks (e.g., task 1-task N). Other objectives (like the recipient objective) are associated with performing a single user task (e.g., task Z).

As described with reference to FIG. 3, user tasks can be modeled using a machine learning model. For example, the machine learning model learns how to model a particular user task during a training phase, as described in FIG. 4. In some embodiments, a machine learning model learning to model a particular user task operates within a machine learning model. For example, as described in FIG. 3, the modeling task modeled by a machine learning model is executed using a head of a multi-headed machine learning model.

FIG. 3 illustrates an example of an architecture of a hierarchical dependent multi-task machine learning model, in accordance with some embodiments of the present disclosure.

Multi-task learning as used herein may refer to a process by which a single machine learning model 300 is trained to perform multiple modeling tasks. A model that is trained using multi-task learning includes one or more shared backbone layers 304 and heads 350, 306, 308, and 312 where each head 350, 306, 308, and 312 is configured to perform a specific modeling task. Each head 350, 306, 308, and 312 includes one or more layers that perform (in an inference mode) and/or learn (in a training mode) the specific modeling task associated with that head, where, as described herein, the modeling tasks are related to particular user tasks.

As used herein, a layer may refer to a sub-structure of a head of the machine learning model that includes a number of nodes (e.g., neurons) that perform a particular computation and are interconnected to nodes of adjacent layers. Nodes in each of the layers sum up values from adjacent nodes and apply an activation function, allowing the layers to detect nonlinear patterns in the input data. Nodes are interconnected by weights, which are tuned during training as described with reference to FIGS. 4 and 5. The adjustment of the weights through training facilitates the machine learning model's ability to predict a reliable and/or accurate output.

As described below, each head 350, 306, 308, and 312 of the hierarchical dependent multi-task machine learning model 360 uses the listwise method to generate an output, e.g., to generate a ranked list of search results. In example 300, each head 350, 306, 308, and 312 of the hierarchical dependent multi-task machine learning model 360 performs listwise ranking, resulting in the each head both inputting and outputting a three-dimensional tensor with dimensions such as (batch size, list size, feature size). In some implementations, each head 350, 306, 308, and 312 of the hierarchical dependent multi-task machine learning model 360 can perform listwise ranking using a two-dimensional input. For example, the two-dimensional input can be (batch size*list size, feature size).

In other embodiments one or more heads of the hierarchical dependent multi-task machine learning model 360 use one or more other ranking methods, such as pointwise ranking or pairwise ranking. In these embodiments, the one or more heads of the hierarchical dependent multi-task machine learning model 360 can input and output two-dimensional tensors that generate a relevance score for each item in the list of search results (e.g., using pointwise ranking) or a relevance score for pairs of items in the list of search results (e.g., using pairwise ranking). In other embodiments, different heads of the hierarchical dependent multi-task machine learning model 360 perform ranking using combinations of different ranking methods (e.g., a first head ranks using the listwise ranking approach, a second head ranks using pointwise ranking, a third head ranks using the listwise ranking approach, etc.)

Multi-task learning approaches improve efficiency and/or facilitate information sharing among heads because multiple different heads of the multi-task learning model receive as input the same set of features determined from the shared backbone. As an example, for an N-headed model, where N is a positive integer, computational efficiency is improved because the features received by each head are computed once (e.g., by the shared backbone) instead of N times as would be done if each head of the model were implemented as an independent machine learning model.

In the example of FIG. 3, the shared backbone 304 of the hierarchical dependent multi-task machine learning model 360 receives input features 302. As described herein, the input features 302 can be three-dimensional and include two-dimensional feature vectors based on the search results (e.g., search results 118 described in FIG. 1) and a one-dimensional feature vector of feature data (e.g., feature data 138 described in FIG. 1 including profile data 142, activity data 144 and/or entity graph 146/knowledge graph 148 data). As described herein, a list of search results is obtained responsive to a specific searcher query and include one or more retrieved items (e.g., content items, such as profile pages, articles, and/or posts) related to a received search request.

The shared backbone 304 of the dependent multi-objective machine learning model 360 can include fully connected layers, pooling layers, and other layers to further extract features of the search query and/or compute features based on the extracted features. The output 334 of the shared backbone can include one or more processed feature vectors representing features of the list of search results, e.g., feature vectors that represent features of the entire list, and/or features of individual items in the list. The output 334 of the shared backbone can be three-dimensional and used as an input to heads 306, 308, and 350. In some embodiments, the output 334 of the shared backbone is concatenated with the two-dimensional feature vector based on the search results (e.g., search results 118 described in FIG. 1). In some embodiments, one or more dimensions of the input feature 302 are duplicated to increase the dimension of the input feature 302.

The task 1 head 306 is a head configured to model task 1. For example, the task 1 head models the send message user task as described with reference to FIG. 2. The task 1 head 306 receives output 334, or the one or more feature vectors generated by the shared backbone 304, which represent feature vectors associated with the search results and outputs one or more ranked lists of the search results with respect to task 1. For example, a send message head modeling the send message user task generates output 336 by ranking the search results according to searcher the likelihood of a searcher sending a message to a recipient. As described with reference to FIG. 2, the send message user task is associated with a first objective such as a searcher objective. The search results ranked according to the first modeling task, e.g., a likelihood of the seller sending a message, are output by the task 1 head 306 as output 336. In example 300, the task 2 head 308 is dependent on the task 1 head 306. For example, a recipient accepting a message is dependent on a searcher sending a message. The relationship of the searcher objective and the recipient objective, which is based on the dependent recipient and searcher user tasks, is modeled by connecting output 336 is to the task 2 head 308.

The task 2 head 308 models a second task. For example, the user task learned by the task 2 head 308 is modeling whether a recipient user will accept a message from a searcher user. In the example, the task 2 head 308 performs a modeling task associated with a second objective (e.g., the recipient objective). As described above, the user task associated with the recipient objective is dependent on a user task associated with the searcher objective (e.g., send message user task). To model such a dependent relationship within the hierarchical dependent multi-task machine learning model 360, the task 2 head 308 receives the output 336 from the task 1 head 306. In operation, the task 2 head 308 receives at least two inputs including output 334, or the one or more feature vectors representing the search results, and output 336, or the list of search results ranked according to the likelihood of a first modeling task (e.g., the modeling task related to the searcher user sending a message task). In some embodiments, the task 2 head 308 includes one or more layers that extract features from the ranked list 336. The one or more layers of the task 2 head 308 algorithmically combine the extracted set of features associated with the ranking according to the likelihood of the searcher sending a message (e.g., features related to output 336) and the features associated with the search results (e.g., features related to output 334). The task 2 head 308 outputs one or more ranked lists of search results with respect to task 2, e.g., the likelihood of a recipient accepting a message from the searcher given the search results, where the task 2 task is user task associated with a second objective (e.g., the recipient's objective). The ranked list of search results generated by the task 2 head 308 are output as output 338 and provided as an input to the final ranking head 312.

The task 3 head 350 receives output 334, generated by the shared backbone 304, or the one or more feature vectors representing the search results, and outputs a ranked list of search results with respect to task 3. For instance, the list of search results is ranked according to the likelihood of a third modeling task. As described above, a single modeling task can be modeled using multiple sub-tasks. For example, to model a searcher user engaging with a recipient (e.g., task 3 modeling task), the task 3 head 350 models additional user tasks such as sending a message to a recipient, viewing a recipient profile, adding a note to the recipient profile, saving the recipient profile, etc. Accordingly, the task 3 head 350 executes multiple machine learning models to learn each sub-task of the single user task The task 3 head is referred to as a nested multi-task machine learning model, where the task 3 head 350 includes a set of multiple heads 354, where each head in the set of multiple heads 354 is configured to perform one or more sub-tasks. For example, searcher each head in the set of multiple heads 354 corresponds to one of the sub-tasks associated with modeling task 3. In some embodiments, the task 3 head 350 includes one or more shared layers 352. The one or more shared layers 352 are configured to further extract features of the one or more features representing the search results (e.g., output 334). Additionally or alternatively, the one or more shared layers 352 may perform one or more processes on output 334, such as normalization, filtering, and/or averaging.

Each of the heads of the set of multiple heads 354 receives the output 334 from the shared layer 352. Each head of the set of multiple heads 354 ranks the search results according to a particular sub-task associated with the task 3. For example, a first head of the set of multiple heads 354 may be configured to model the searcher engagement (e.g., the user task 3) with respect to sending a message (e.g., a send message sub-task associated with the engagement user task). In the example, the first head of the set of multiple heads 354 performs a similar modeling task to the modeling task of the task 1 head 306. In some embodiments, the first head of the set of multiple heads 354 includes similar layers to the layers of the task 1 head 306, which are configured to rank the search result according to the likelihood of the searcher sending a message. A second head of the set of multiple heads 354 may be configured to model the searcher engagement with respect to viewing a profile (e.g., a view profile sub-task associated with the engagement user task). The view profile head of the set of multiple heads 354 may be configured to rank the search results according to likelihood of the searcher viewing the recipient's profile.

In some embodiments, one or more heads of the set of multiple heads 354 are dependent on one or more other heads of the set of multiple heads 354. In other words, a first sub-task modeled using a head of the set of multiple heads 354 can be dependent on a second sub-task modeled using a head of the set of multiple heads 354. For example, as shown in the dependency network 200 of FIG. 2, the add note task 206 (which is a user task used to model the searcher engagement) is dependent on the view profile engagement task 204 (which is another user task used to model the searcher engagement).

Referring back to FIG. 3, the task 3 head 350 may include a head configured to rank the search results according to the likelihood of the searcher viewing the recipient's profile (e.g., a view profile sub-task associated with the engagement user task). The ranking generated by such a head (e.g., the output of the head) may be used as an input to a subsequent head configured to rank the search results according to the likelihood of the searcher adding a note to the recipient's profile (e.g., a “add note” sub-task associated with the engagement user task).

In some embodiments, the task 3 head 350 ranks a list of search results given the first objective, e.g. the likelihood of searcher engagement, by algorithmically combining the output of each of the heads in the set of multiple heads 354. In other embodiments, the task 3 head 350 ranks the search results, using a nested final head 356. The final head 356 is nested because it executes within a head (e.g., the task 3 head 350). The nested final ranking head 356 receives inputs from one or more heads of the set of multiple heads 354. In some embodiments, the nested final ranking head 356 includes one or more layers that extract features from the outputs of the one or more heads of the set of multiple heads 354 and algorithmically combines the extracted sets of features based on the outputs of the one or heads of the set of multiple heads 354. Subsequently, the nested final ranking head 356 can rank a list of search results, e.g., recipient users, according to the multi-task first objective, e.g., searcher engagement.

The task 3 head 350 generates and outputs output 340, or one or more ranked lists of search results with respect to task 3, where, in example 300, modeling task 3 includes modeling multiple sub-tasks. For example, the task 3 head 350 outputs as output 340 a ranked list of search results according to the likelihood of the searcher engaging with the recipient by combining the likelihood of the searcher sending a message to the recipient (e.g., the output of a send message head of the set of multiple heads 354 of the task 3 head 350), the likelihood of the searcher viewing the recipient's profile (e.g., the output of a view profile head of the set of multiple heads 354 of the task 3 head 350), and/or the likelihood of the searcher adding a note to the recipient's profile (e.g., the output of an add note head of the set of multiple heads 354 of the task 3 head 350). The ranked search results are provided as an input to the final ranking head 312.

In some implementations, the output 336 of the task 1 head 306 is specific to the searcher engagement associated with sending a message (e.g., one user task of multiple user tasks associated with searcher engagement), while the output 340 of the task 3 head 350 is not specific to the searcher engagement associated with a specific user task, such as the sending of a message. For example, the output 340 of the task 3 head 350 can indicate a ranking of the search results according to a searcher engaging with the recipient, where engaging with the recipient is defined based on one or more sub-tasks such as sending a message to a recipient, viewing a recipient profile, adding a note to the recipient profile, and/or saving the recipient profile. In contrast, the output 336 of the task 2 head 306 indicates a ranking of the search results according to a searcher sending a message to a recipient. In some embodiments, the task 3 head 350 does model the “send a message” user task (implemented using a “send a message” head of the set of multiple heads 354) because the task 1 head 306 has learned to rank the search results according to the engagement user task “send a message.”

The final ranking head 312 receives inputs including output 338, or a ranked list of search results according to the second objective, e.g., the likelihood of a recipient accepting a message from the searcher based on the searcher sending a message to the recipient, and output 340, or a ranked list of search results according to the first objective, e.g., the likelihood of a searcher engaging with a recipient. In some embodiments, the final ranking head 312 includes one or more layers that extract sets of features from the ranked lists 338 and 340 and algorithmically combine the sets of features extracted from the ranked lists 338 and 340. Subsequently, the final ranking head 312 performs ranking using the sets of features extracted from the ranked lists 338 and 340. The final ranking head 312 outputs a balanced multi-objective ranking 314 based on optimizing both the first objective, e.g., the searcher's objective, and the second objective, e.g., the recipient's objective. The balanced multi-objective ranking 314 ranks search results (e.g., a list of recipients relevant to the searcher's search query) according to the likelihood of the searcher engaging with the recipient and the likelihood of the recipient interacting with the searcher. In other words, the balanced multi-objective ranking 314 includes a permutation of items of the search result, where the items of the search result are associated with a search request.

FIG. 4 is a flow diagram of an example method for training a multi-headed machine learning model, in accordance with some embodiments of the present disclosure. As described herein, the hierarchical dependent multi-task machine learning model 450 is a multi-task machine learning model. In some implementations, each head (e.g., task 2 head 408, task 1 head 406, and task 3 head 410) of the hierarchical dependent machine multi-task learning model 450 is trained to perform a specific modeling task (including a sub-task of a specific user task). However, each head (e.g., task 2 head 408, task 1 head 406, and task 3 head 410) is trained as part of the single hierarchical dependent multi-task machine learning model 450 using end-to-end training. Using end-to-end training to train the hierarchical dependent multi-headed machine learning model 450 facilitates the joint learning of the heads of the hierarchical dependent multi-headed machine learning model 450 (e.g., all of the heads are trained using the same training input data). For example, as described with reference to FIG. 3, training the hierarchical dependent multi-headed machine learning model 450 using end-to-end training allows the final ranking head 312 to be tuned according to the difference between the predicted balanced multi-objective ranking 314 and a manually ranked balanced search result. Such automatic tuning is different from and an improvement over conventional systems that manually tune the algorithmic combination of a first ranked result determined by a first machine learning model (e.g., optimizing a first objective) and a second ranked result determined by a second machine learning model (e.g., optimizing the second objective).

In FIG. 4, three heads are illustrated for case of discussion. Other heads (e.g., the nested heads of the task 3 head 350, and/or the final ranking head 312, as described with reference to FIG. 3) of the hierarchical dependent multi-task machine learning model 450 can be trained in a similar manner as described with reference to FIG. 4.

In the example training system 400, a training module 430 provides training data to the shared backbone 404 of the hierarchical dependent multi-task machine learning model 450, illustrated by dashed line 412. For example, the training module 430 provides a feature vector of search results (e.g., input features 302 described with reference to FIG. 3) to the shared backbone 404 such that the shared backbone 404 learns to further extract features. The feature vector of search results provided to the shared backbone 404 includes, for example, training lists of search results and/or training feature data (e.g., search results 118 and feature data 138, including profile data 142, activity data 144, entity graph 146 and/or knowledge graph 148 data as described in FIG. 1 used for training).

As shown by solid lines 412, 422, 424, and 426, the heads of the hierarchical dependent multi-task machine learning model 450 (e.g., task 1 head 406, task 2 head 408, and task 3 head 410) receive the one or more feature vectors from the shared backbone 404. The task 1 head 406, task 2 head 408, and task 3 head 410 each determine ranked search results using the feature representation of search results determined from the shared backbone 404.

As described herein, in one embodiment, each head is trained to perform a ranking modeling task using, for example, the listwise learning-to-rank method. Accordingly, the task 1 head 406 is trained to output a ranked list of search results according to a first modeling task which can be associated with a first objective, e.g., the likelihood of a searcher sending a message to the recipient. The task 2 head 408 is trained to output a ranked list of search results according to a second modeling task which can be associated with a second objective, e.g., the likelihood of a recipient accepting a message from the searcher. The task 3 head 410 is trained to output a ranked list of search results according to a third modeling task which can be associated with the first objective, e.g., the likelihood of a searcher engaging with a recipient (e.g., performing one or more user tasks such as sending a message to a recipient, viewing a recipient profile, adding a note to the recipient profile, saving the recipient profile, etc.).

As described with reference to FIG. 5, each output of each head (task 1 head 406, task 2 head 408, and task 3 head 410), which is a ranked list of search results with respect to corresponding modeling task 1, task 2 and task 3 tasks, is compared to a ground truth ranked list of search results with respect to the corresponding user tasks because the modeling tasks are used to predict user tasks. An error is determined by comparing the output of each head (e.g., a predicted ranked list of search results) to the ground truth ranked list of search results corresponding to the head. For example, a predicted ranked list of search results with respect to modeling task 1 is compared to a ground truth ranked list of search results with respect to user task 1 to determine an error of task 1 head 406, a predicted ranked list of search results with respect to modeling task 2 is compared to a ground truth ranked list of search results with respect to user task 2 to determine an error of task 2 head 408, and a predicted ranked list of search results with respect to modeling task 3 is compared to a ground truth ranked list of search results with respect to user task 3 to determine an error of task 3 head 410. The error is the difference between the predicted ranked list of search results with respect to the corresponding modeling tasks and the ground truth ranked list of search results with respect to the corresponding user tasks. The error of each head (task 1 head 406, task 2 head 408 and task 3 head 410) is passed to the shared backbone 404 such that the shared backbone 404 adjusts the way feature vectors are extracted from the training lists of search results and/or training feature data such as search results 118 and feature data 138, including profile data 142, activity data 144, entity graph 146 and/or knowledge graph 148 data as described in FIG. 1. The error that is propagated from each head to the shared backbone is illustrated as dashed lines 432, 343, and 436. In some embodiments, the error determined from dependent heads are shared. For example, the error associated with the task 2 head 408 is passed back to task 1 head 406 such that the task 1 head 406 is tuned according to the error of the task 2 head 408.

FIG. 5 is a flow diagram of an example method for training a head of a multi-headed machine learning model using supervised learning, in accordance with some embodiments of the present disclosure.

Supervised learning is a method of training a machine learning model given input-output pairs. An input-output pair (e.g., training input 502 and corresponding actual output 518) is an input with an associated known output (e.g., an expected output, a labeled output, a ground truth). An actual output 518 may be manually ranked search results according to a particular user task and/or stored historically ranked search results according to the particular user task. A training input 502 (e.g., a list of search results provided to the machine learning model 450 or model 360 during a training phase) is associated with a ranked list of search results with respect to a particular user task. For example, when the ML head 508 is a task 1 head (e.g., task 1 head 406 of model 450), the search result used as an actual output 518 is the ranked list of search results with respect to user task 1. Additionally, when the ML head 508 is a task 2 head (e.g., task 2 head 408 of model 450), the search result used as an actual output 518 is the ranked list of search results with respect to user task 2. In FIG. 5, the ML head 508 represents any head of the multi-headed machine learning model (e.g., model 450, model 360). Additionally, training system 500 illustrates that the shared backbone 504 can be trained based on the accuracy of the ML head 508 in performing its modeling task.

As described herein, the training input 502 can include training data provided to the shared backbone 504. Training data is any data used during a training period to teach the ML head 508 how to model a user task. For example, the training module 530 provides, as training input 502, a feature vector of search results to the shared backbone 504 such that the shared backbone 504 learns to further extract features. The feature representation of search results (e.g., training input 502) provided to the shared backbone 504 includes, for example, lists of search results and/or feature data (e.g., search results 118 and feature data 138, including profile data 142, activity data 144, entity graph 146 and/or knowledge graph 148 data as described in FIG. 1 used for training).

The ML head 508 receives the features from the shared backbone 504 and predicts output 506 by applying nodes in one or more layers of the ML head 508 to the features extracted from the shared backbone 504. As described herein, a layer may refer to a sub-structure of the ML head 508 of the machine learning model (e.g., model 360, model 450). Layers include a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error determined by comparing the actual output 518 to the predicted output 506. The adjustment of the weights during training facilitates the machine learning model's (e.g., model 360, model 450) ability to predict a reliable and/or accurate output. In operation, the comparator 510 compares the predicted output 506 to the actual expected (e.g., ground truth) output 518 to determine an amount of error or difference between the predicted output 506 and the actual output 518.

As described herein, there are multiple learning-to-rank algorithms, including pointwise, pairwise, and listwise. Each of the learning-to-rank algorithms returns an output in a different format. For example, when the ML head 508 is trained to rank according to the pointwise method, the actual output 518 includes labeled items of a search result with a corresponding relevance score for each labeled item. When the ML head 508 is trained to rank according to the pairwise method, the actual output 518 includes pairs of search entries with their corresponding labels (e.g., each pair has a corresponding label) indicating which entry in the pair of entries is more relevant. When the ML head 508 is trained to rank according to the listwise method, the actual output 518 includes a set of ranked lists, where each ranked list in the set of ranked lists has a corresponding relevance label.

As described herein, the error (represented by error signal 512) is determined by comparing the predicted output 506 (e.g., permutations of search results computed by the ML head 508) to the actual output 518 (e.g., labeled permutations of search results) using the comparator 510. The error signal 512 is used to adjust the weights in the ML head 508 such that after a set of training iterations the ML head 508 converges, e.g., changes (or learns) over time to generate an acceptably accurate (e.g., accuracy satisfies a defined tolerance or confidence level) predicted output 506 using the input-output pairs. The ML head 508 may be trained using a backpropagation algorithm, for instance. The backpropagation algorithm operates by propagating the error signal 512 through one or more other ML heads (not shown) and/or the shared backbone 504. The error signal 512 may be calculated each iteration (e.g., each pair of training inputs 502 and associated actual outputs 518), batch, and/or epoch and propagated through all of the algorithmic weights in the one or more ML heads 508 and/or shared backbone 504 such that the algorithmic weights adapt based on the amount of error. The error is computed using a loss function. Non-limiting examples of loss functions may include the square error function, the room mean square error function, and/or the cross-entropy error function. In some embodiments, ML heads of the hierarchical dependent multi-task machine learning model are trained using different loss functions. That is, the comparator 510 may determine the error between the actual output 518 and the predicted output 506 using different loss functions for different ML heads.

The weighting coefficients of the ML head 508 may be tuned to reduce the amount of error thereby minimizing the differences between (or otherwise converging) the predicted output 506 and the actual output 518. The ML head 508 may be trained until the error determined at the comparator 510 is within a certain threshold (or a threshold number of batches, epochs, or iterations have been reached).

FIG. 6 is a block diagram of a computing system that includes a hierarchical dependent multi-task machine learning model, in accordance with some embodiments of the present disclosure.

In the embodiment of FIG. 6, a computing system 600 includes one or more user systems 610, a network 622, an application software system 630, a hierarchical dependent multi-task machine learning model 620, a data storage system 640, and event logging service 670.

All or at least some components of the hierarchical dependent multi-task machine learning model 620 are implemented at the user system 610, in some implementations. For example, hierarchical dependent multi-task machine learning model 620 is implemented directly upon a single client device such that ranked search results are displayed to a user (or otherwise communicated) on-device without the need to communicate with, e.g., one or more servers, over the Internet. Dashed lines are used in FIG. 6 to indicate that all or portions of hierarchical dependent multi-task machine learning model 620 can be implemented directly on the user system 610, e.g., the user's client device. In other words, both user system 610 and hierarchical dependent multi-task machine learning model 620 can be implemented on the same computing device.

Components of the computing system 600 including the hierarchical dependent multi-task machine learning model 620 are described in more detail herein.

A user system 610 includes at least one computing device, such as a personal computing device, a server, a mobile computing device, a wearable electronic device, or a smart appliance, and at least one software application that the at least one computing device is capable of executing, such as an operating system or a front end of an online system. Many different user systems 610 can be connected to network 622 at the same time or at different times. Different user systems 610 can contain similar components as described in connection with the illustrated user system 610. For example, many different end users of computing system 600 can be interacting with many different instances of application software system 630 through their respective user systems 610, at the same time or at different times.

User system 610 includes a user interface 612. User interface 612 is installed on or accessible to user system 610 by network 622. The user interface 612 enables user interaction with the search engine 642 (in the form of a search request) and/or the ranked search results determined by the hierarchical dependent multi-task machine learning model 620.

The user interface 612 includes, for example, a graphical display screen that includes graphical user interface elements such as at least one input box or other input mechanism and a space on a graphical display into which ranked search results (or other digital content) can be loaded for display to the user. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, the graphical display may be defined using a three-dimensional coordinate system.

In some implementations, user interface 612 enables the user to upload, download, receive, send, or share of other types of digital content items, including posts, articles, comments, and shares, to initiate user interface events, and to view or otherwise perceive output such as data and/or digital content produced by application software system 630, hierarchical dependent multi-task machine learning model 620, and/or content distribution service 638. For example, user interface 612 can include a graphical user interface (GUI), a conversational voice/speech interface, a virtual reality, augmented reality, or mixed reality interface, and/or a haptic interface. User interface 612 includes a mechanism for logging in to application software system 630, clicking or tapping on GUI user input control elements, and interacting with digital content items such as ranked search results. Examples of user interface 612 include web browsers, command line interfaces, and mobile app front ends. User interface 612 as used herein can include application programming interfaces (APIs).

In the example of FIG. 6, user interface 612 includes a front-end user interface component of application software system 630. For example, user interface 612 can be directly integrated with other components of any user interface of application software system 630. In some implementations, access to content of the application software system 630 and/or the hierarchical dependent multi-task machine learning model 620 is limited to registered users of application software system 630.

Network 622 includes an electronic communications network. Network 622 can be implemented on any medium or mechanism that provides for the exchange of digital data, signals, and/or instructions between the various components of computing system 600. Examples of network 622 include, without limitation, a Local Area Network (LAN), a Wide Area Network (WAN), an Ethernet network or the Internet, or at least one terrestrial, satellite or wireless link, or a combination of any number of different networks and/or communication links.

Application software system 630 includes any type of application software system that provides or enables the creation, upload, and/or distribution of at least one form of digital content, including ranked digital content. In some implementations, portions of hierarchical dependent multi-task machine learning model 620 are components of application software system 630. Components of application software system 630 can include an entity graph 632 and/or knowledge graph 634, a user connection network 636, a content distribution service 638, a search engine 642, and a training manager 644.

In the example of FIG. 6, application software system 630 includes an entity graph 632 and/or a knowledge graph 634. Entity graph 632 and/or knowledge graph 634 include data organized according to graph-based data structures that can be traversed via queries and/or indexes to determine relationships between entities. An example of an entity graph is shown in FIG. 7, described herein. For instance, as described in more detail with reference to FIG. 7, entity graph 632 and/or knowledge graph 634 can be used to compute various types of relationship weights, affinity scores, similarity measurements, and/or statistics between, among, or relating to entities.

Entity graph 632, 634 includes a graph-based representation of data stored in data storage system 640, described herein. For example, entity graph 632, 634 represents entities, such as users, organizations (e.g., companies, schools, institutions), and content items (e.g., job postings, announcements, articles, comments, and shares, as nodes of a graph). Entity graph 632, 634 represents relationships, also referred to as mappings or links, between or among entities as edges, or combinations of edges, between the nodes of the graph. In some implementations, mappings between different pieces of data used by application software system 630 are represented by one or more entity graphs. In some implementations, the edges, mappings, or links indicate online interactions or activities relating to the entities connected by the edges, mappings, or links. For example, if a user accepts a communication from another user, an edge may be created connecting the receiving user entity with the sending user entity in the entity graph, where the edge may be tagged with a label such as “accepted.”

Portions of entity graph 632, 634 can be automatically re-generated or updated from time to time based on changes and updates to the stored data, e.g., updates to entity data and/or activity data. Also, entity graph 632, 634 can refer to an entire system-wide entity graph or to only a portion of a system-wide graph. For instance, entity graph 632, 634 can refer to a subset of a system-wide graph, where the subset pertains to a particular user or group of users of application software system 630.

In some implementations, knowledge graph 634 is a subset or a superset of entity graph 632. For example, in some implementations, knowledge graph 634 includes multiple different entity graphs 632 that are joined by cross-application or cross-domain edges. For instance, knowledge graph 634 can join entity graphs 632 that have been created across multiple different databases or across different software products. In some implementations, the entity nodes of the knowledge graph 634 represent concepts, such as product surfaces, verticals, or application domains. In some implementations, knowledge graph 634 includes a platform that extracts and stores different concepts that can be used to establish links between data across multiple different software applications. Examples of concepts include topics, industries, and skills. The knowledge graph 634 can be used to generate and export content and entity-level embeddings that can be used to discover or infer new interrelationships between entities and/or concepts, which then can be used to identify related entities. As with other portions of entity graph 632, knowledge graph 634 can be used to compute various types of relationship weights, affinity scores, similarity measurements, and/or statistical correlations between or among entities and/or concepts.

Knowledge graph 634 includes a graph-based representation of data stored in data storage system 640, described herein. Knowledge graph 634 represents relationships, also referred to as links or mappings, between entities or concepts as edges, or combinations of edges, between the nodes of the graph. In some implementations, mappings between different pieces of data used by application software system 630 or across multiple different application software systems are represented by the knowledge graph 634.

User connection network 636 includes, for instance, a social network service, professional social network software and/or other social graph-based applications. Content distribution service 638 includes, for example, a chatbot or chat-style system, a messaging system, such as a peer-to-peer messaging system that enables the creation and exchange of messages among users of application software system 630, or a news feed. Search engine 642 includes a search engine that enables users of application software system 630 to input and execute search queries on user connection network 636, entity graph 632, knowledge graph 634, and/or one or more indexes or data stores that store retrievable items, such as digital items that can be retrieved and included in a list of search results. In some implementations, one or more portions of hierarchical dependent multi-task machine learning model 620 are in bidirectional communication with search engine 642. Application software system 630 can include, for example, online systems that provide social network services, general-purpose search engines, specific-purpose search engines, messaging systems, content distribution platforms, e-commerce software, enterprise software, or any combination of any of the foregoing or other types of software.

In some implementations, a front-end portion of application software system 630 can operate in user system 610, for example as a plugin or widget in a graphical user interface of a web application, mobile software application, or as a web browser executing user interface 612. In an embodiment, a mobile app or a web browser of a user system 610 can transmit a network communication such as an HTTP request over network 622 in response to user input that is received through a user interface provided by the web application, mobile app, or web browser, such as user interface 612. A server running application software system 630 can receive the input from the web application, mobile app, or browser executing user interface 612, perform at least one operation using the input, and return output to the user interface 612 using a network communication such as an HTTP response, which the web application, mobile app, or browser receives and processes at the user system 610.

In the example of FIG. 6, application software system 630 includes a content distribution service 638. The content distribution service 638 can include a data storage service, such as a web server, which stores digital content items, and transmits ranked digital content items to users using the hierarchical dependent multi-task machine learning model 620. Alternatively, or in addition, the hierarchical dependent multi-task machine learning model 620 can interface with one or more components or services of content distribution service 638, such as one or more recommendation models (e.g., content you may be interested in, people you may know, etc.) to obtain information to be used for ranking.

In some embodiments, content distribution service 638 processes requests from, for example, application software system 630 and/or hierarchical dependent multi-task machine learning model 620 and distributes digital content items to user systems 610 in response to requests. A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, or a page load. In some implementations, content distribution service 638 is part of application software system 630 or ranking system (such as ranking system 120 of FIG. 1). In other implementations, content distribution service 638 interfaces with application software system 630 and/or hierarchical dependent multi-task machine learning model 620, for example, via one or more application programming interfaces (APIs).

In the example of FIG. 6, application software system 630 includes a search engine 642. Search engine 642 is a software system designed to search for and retrieve information by executing queries on data stores, such as databases, connection networks, and/or graphs. The queries are designed to find information that matches specified criteria, such as keywords and phrases. For example, search engine 642 is used to retrieve data by executing queries on various data stores of data storage system 640 or by traversing entity graph 632, 634.

In the example of FIG. 6, application software system 630 includes a training manager 644. The training manager 644 trains the hierarchical dependent multi-task machine learning model 620 during a training phase. For example, the training manager 644 can apply input-output pairs to each head of the hierarchical dependent multi-task machine learning model 620 using supervised training to train each head of the hierarchical dependent multi-task machine learning model 620 to perform a modeling task related to a user task. An input-output pair (e.g., training input and corresponding actual output) is an input with an associated known output (e.g., an expected output, a labeled output, a ground truth). A training input (e.g., a list of search results provided to the hierarchical dependent multi-task machine learning model 620 during a training phase) is associated with a ranked list of search results with respect to a particular user task. For example, when a head of the hierarchical dependent multi-task machine learning model 620 is a task 1 head (e.g., task 1 head 406 of model 450), the search result used as an actual output is the ranked list of search results with respect to user task 1. Additionally, when a head of the hierarchical dependent multi-task machine learning model 620 is a task 2 head (e.g., task 2 head 408 of model 450), the search result used as an actual output is the ranked list of search results with respect to user task 2.

The hierarchical dependent multi-task machine learning model 620 ranks digital content using search results determined by search engine 642 or other applications of application software system 630, based on input received via user interface 612 and/or other data sources. Embodiments of hierarchical dependent multi-task machine learning model 620 are shown and described in more detail with reference to, for example, FIG. 1, FIG. 3, FIG. 5, and FIG. 6.

Event logging service 670 captures and records network activity data generated during operation of application software system 630 and/or hierarchical dependent multi-task machine learning model 620, including user interface events generated at user systems 610 via user interface 612, in real time, and formulates the user interface events into a data stream that can be consumed by, for example, a stream processing system. Examples of network activity data include profile views, profile loads, search requests, clicks on messages or graphical user interface control elements, the creation, editing, sending, and viewing of messages, and social action data such as likes, shares, comments, and social reactions (e.g., “insightful,” “curious,” etc.). For instance, when a user of application software system 630 via a user system 610 clicks on a user interface element, such as a message, a link, or a user interface control element such as a view, comment, share, or reaction button, or uploads a file, or creates a message, loads a web page, or scrolls through a feed, etc., event logging service 670 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile.

For instance, when a user enters a search request and subsequently interacts with the search results, event logging service 670 stores the corresponding event data in a log. Event logging service 670 generates a data stream that includes a record of real-time event data for each user interface event that has occurred. Event data logged by event logging service 670 can be pre-processed and anonymized as needed so that it can be used, for example, to generate relationship weights, affinity scores, similarity measurements, and/or to formulate training data for the hierarchical dependent multi-task machine learning model 620.

Data storage system 640 includes data stores and/or data services that store digital data received, used, manipulated, and produced by application software system 630 and/or hierarchical dependent multi-task machine learning model 620, including search requests, search results, ranked search results, profile data (e.g., profile data 142 as described with reference to FIG. 1), activity data (e.g., activity data 144 as described with reference to FIG. 1), machine learning model training data, machine learning model parameters, and machine learning model inputs and outputs, such as machine-generated classifications and machine-generated score data.

In the example of FIG. 6, data storage system 640 includes a profile data store 652, an activity data store 654, and a training data store 656. Profile data store 652 stores profile data such as data relating to users, companies, jobs, and other entities, which are used by the search engine 642 to, for example, obtain search results. Activity data store 654 stores activity data such as network activity, e.g., user interface event data extracted from application software system 630 and/or event logging service 670, which are used by the search engine 642 to determine search results. Training data store 656 stores training data including training inputs (e.g., one or more feature vectors representing a list of search results associated with a search query) and labeled outputs (e.g., manually labeled search results).

In some embodiments, data storage system 640 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of data storage system 640 can be configured to store data produced by real-time and/or offline (e.g., batch) data processing. A data store configured for real-time data processing can be referred to as a real-time data store. A data store configured for offline or batch data processing can be referred to as an offline data store. Data stores can be implemented using databases, such as key-value stores, relational databases, and/or graph databases. Data can be written to and read from data stores using query technologies, e.g., SQL or NoSQL.

A key-value database, or key-value store, is a nonrelational database that organizes and stores data records as key-value pairs. The key uniquely identifies the data record, i.e., the value associated with the key. The value associated with a given key can be, e.g., a single data value, a list of data values, or another key-value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

Data storage system 640 resides on at least one persistent and/or volatile storage device that can reside within the same local network as at least one other device of computing system 600 and/or in a network that is remote relative to at least one other device of computing system 600. Thus, although depicted as being included in computing system 600, portions of data storage system 640 can be part of computing system 600 or accessed by computing system 600 over a network, such as network 622.

While not specifically shown, it should be understood that any of user system 610, application software system 630, hierarchical dependent multi-task machine learning model 620, data storage system 640, and event logging service 670 includes an interface embodied as computer programming code stored in computer memory that when executed causes a computing device to enable bidirectional communication with any other of 610, application software system 630, hierarchical dependent multi-task machine learning model 620, data storage system 640, and event logging service 670 using a communicative coupling mechanism. Examples of communicative coupling mechanisms include network interfaces, inter-process communication (IPC) interfaces and application program interfaces (APIs).

Each of user system 610, application software system 630, hierarchical dependent multi-task machine learning model 620, data storage system 640, and event logging service 670 is implemented using at least one computing device that is communicatively coupled to electronic communications network 622. Any of user system 610, application software system 630, hierarchical dependent multi-task machine learning model 620, data storage system 640, and event logging service 670 can be bidirectionally communicatively coupled by network 622. User system 610 as well as other different user systems (not shown) can be bidirectionally communicatively coupled to application software system 630 and/or hierarchical dependent multi-task machine learning model 620.

A typical user of user system 610 can be an administrator or end user of application software system 630 or hierarchical dependent multi-task machine learning model 620. User system 610 is configured to communicate bidirectionally with any of application software system 630, hierarchical dependent multi-task machine learning model 620, data storage system 640, and event logging service 670 over network 622.

Terms such as component, module, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 610, application software system 630, hierarchical dependent multi-task machine learning model 620, data storage system 640, and event logging service 670 are implemented using computer software, hardware, or software and hardware, and can include combinations of automated functionality, data structures, and digital data, which are represented schematically in the figures. User system 610, application software system 630, hierarchical dependent multi-task machine learning model 620, data storage system 640, and event logging service 670 are shown as separate elements in FIG. 6 for case of discussion but, except as otherwise described, the illustration is not meant to imply that separation of these elements is required. The illustrated systems, services, and data stores (or their functionality) of each of user system 610, application software system 630, hierarchical dependent multi-task machine learning model 620, data storage system 640, and event logging service 670 can be divided over any number of physical systems, including a single physical computer system, and can communicate with each other in any appropriate manner.

FIG. 7 is an example of an entity graph, in accordance with some embodiments of the present disclosure.

The entity graph 700 can be used by an application software system, e.g., a social network service, to support a user connection network, in accordance with some embodiments of the present disclosure. The entity graph 700 can be used (e.g., queried or traversed) to obtain search results that can be used as an input to a ranking system (such as ranking system 120 and/or hierarchical dependent multi-task machine learning model 150 described in FIG. 1).

The entity graph 700 includes nodes, edges, and data (such as labels, weights, or scores) associated with nodes and/or edges. Nodes can be weighted based on, for example, similarity with other nodes, edge counts, or other types of computations, and edges can be weighted based on, for example, affinities, relationships, activities, similarities, or commonalities between the nodes connected by the edges, such as common attribute values (e.g., two users have the same job title or employer, or two users are n-degree connections in a user connection network, where n is a positive integer).

A graphing mechanism is used to create, update and maintain the entity graph. In some implementations, the graphing mechanism is a component of the database architecture used to implement the entity graph 700. For instance, the graphing mechanism can be a component of data storage system 640 and/or application software system 630, shown in FIG. 6, and the entity graphs created by the graphing mechanism can be stored in one or more data stores of data storage system 640.

The entity graph 700 is dynamic (e.g., continuously updated) in that it is updated in response to occurrences of interactions between entities in an online system (e.g., a user connection network) and/or computations of new relationships between or among nodes of the graph. These updates are accomplished by real-time data ingestion and storage technologies, or by offline data extraction, computation, and storage technologies, or a combination of real-time and offline technologies. For example, the entity graph 700 is updated in response to updates of user profiles, viewing one or more user profiles, the creation or deletion of user connections with other users, and the creation and distribution of new content items, such as messages, posts, articles, comments, and shares. As another example, the entity graph 700 is updated as new computations are computed, for example, as new relationships between nodes are created based on statistical correlations or machine learning model output.

The entity graph 700 includes a knowledge graph that contains cross-application links. For example, profile data, activity data, and the like obtained from one or more contextual resources can be linked with entities and/or edges of the entity graph.

In the example of FIG. 7, entity graph 700 includes entity nodes, which represent entities, such as user nodes (e.g., User 1, User 2, User 3, User 4), and job nodes (e.g., Job 1, Job 2). Entity graph 700 also includes attribute nodes, which represent attributes or profile data (e.g., job title data, skill data,) of entities. Examples of attribute nodes include title nodes (e.g., Title 1, Title 2), company nodes (e.g., Company 1), and skill nodes (e.g., Skill 1, Skill 2).

Entity graph 700 also includes edges. The edges individually and/or collectively represent various different types of relationships between or among the nodes. Data can be linked with both nodes and edges. For example, when stored in a data store, each node is assigned a unique node identifier and each edge is assigned a unique edge identifier. The edge identifier can be, for example, a combination of the node identifiers of the nodes connected by the edge and a timestamp that indicates the date and time at which the edge was created. For instance, in the graph 700, edges between user nodes can represent online social interactions between the users represented by the nodes. As an example, in the entity graph 700, User 1 has clicked on the profile of User 5 by virtue of the CLICKED edge between User 1 and User 4. User 1 has sent a message to the profile of User 2 and User 3 by virtue of the SEND MESSAGE edges between User 1 and User 2, and User 1 and User 3.

In the entity graph 700, edges can represent attributes of users by the nodes connected by the edges. For example, User 4 is associated with Skill 1, Skill 2, and Title 2, by virtue of the HAS edge between User 4 and Skill 1, Skill 2, and Title 2. Similarly, User 1 and User 2 are associated with Title 1 by virtue of the HAS edge between User 1 and Title 1, and User 2 and Title 1. Similarly, User 2 and User 3 are associated with Company 1 by virtue of the EMPLOYED BY edge between Company 1 and User 2, and Company 1 and User 3.

In some implementations, combinations of nodes and edges are used to compute various scores, and those scores are used by various components of the search engine to, for example, generate search results. Additionally or alternatively, the combinations of nodes and edges are used to extract feature vector, for example, by a feature extractor such as feature extractor 122 described in FIG. 1 For instance, based on relative edge counts, a skill affinity score computed for User 4 might be higher than the skill affinity score computed for User 2 because User 4 is associated with a greater number of Skill nodes than the Skill nodes associated with User 2 (e.g., User 4 is associated with Skill 1 and Skill 2, while User 2 is associated with Skill 1). Similarly, a company 1 affinity score computed for User 3 might be higher than the company 1 affinity score computed for User 4 because User 4 is not associated with the Company 1 node. That is, User 3 is associated with company 1 and user 4 is not associated with company 1.

The examples shown in FIG. 7 and the accompanying description, above are provided for illustration purposes. This disclosure is not limited to the described examples. For example, while the examples in FIG. 7 are described with reference to computing scores used by various components of the search engine, the search engine can identify search results associated with a search query using other data sources (e.g., not entity graph 700).

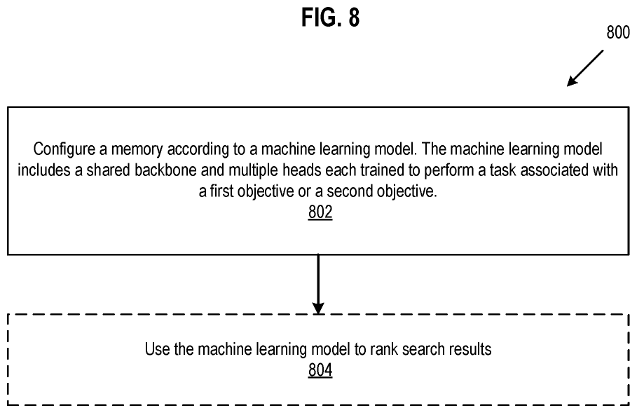

FIG. 8 is a flow diagram of an example method for using a hierarchical dependent multi-task machine learning model, in accordance with some embodiments of the present disclosure.

The method 800 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 800 is performed by one or more components of the ranking system 120 and/or hierarchical dependent multi-task machine learning model 150 of FIG. 1 or the hierarchical dependent multi-task machine learning model 650 of FIG. 6. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 802, a processing device configures a memory according to a machine learning model. The machine learning model includes a shared backbone and multiple heads each trained to perform a modeling task associated with a first objective or a second objective. Embodiments of the machine learning model are configured similarly to the hierarchical dependent multi-task machine learning model 350 described in FIG. 3.

At operation 804, the processing device optionally uses the configured machine learning model. The configured machine learning model receives search results using content data 162 retrieved from content items 160 stored in the storage system 140 and/or stored in other one or more external databases/servers, as described in FIG. 1. As described herein, a search result includes a list of search results including one or more items related to (e.g., retrieved by a search engine in response to) a search query. The search result may be received by the machine learning model in a raw format (e.g., a list of search results associated with the search query). Additionally or alternatively, features may be extracted from the search results and provided to the machine learning model (e.g., by the feature extractor 122 as described with reference to FIG. 1). Accordingly, one or more input features are received by the machine learning model. The processing device uses the machine learning model to rank the search result. Specifically, the hierarchical dependent multi-task machine learning model 360 described in FIG. 3 balances optimization of both objectives (e.g., the first objective and the second objective) to produce a ranked search result including one or more entries. The ranked search result represents one or more entries that are related to a search request associated with a first objective (e.g., a searcher objective, as described herein) and one or more entries that depend on a user task of the first objective. For example, the ranked search result represents one or more entries that are likely to result in a recipient response (e.g., a recipient objective, as described herein) should the searcher decide to interact with the searcher.

In some implementations, the first objective contradicts the second objective. For example, contradicting objectives may refer to opposing goals, such as a goal to perform “X” and a goal to perform “not X”, where X may refer to a specific activity or purpose for which the online system may be used.

In some implementations, the modeling task performed by each head is a listwise ranking task.

In some implementations, a second modeling task associated with the first objective includes a plurality of sub-tasks. For example, the second modeling task associated with the first objective may be a modeling task related to modeling searcher engagement (e.g., a user task), where searcher engagement is measured, for example, according to the searcher sending a message to the recipient (e.g., sub-task 1), viewing on a recipient profile (e.g., sub-task 2), and saving the recipient profile (e.g., sub-task 3). In some implementations, a third head of the machine learning model is a nested multi-task machine learning mode where each head of the nested multi-task machine learning model performs a sub-task of the plurality of sub-tasks. For example, the third head of the multi-task machine learning model learns searcher engagement (e.g., a user task), where, as described above, searcher engagement is measured according to one or more sub-tasks. As a result, searcher engagement is modeled as a multi-task machine learning model within a multi-task machine learning model (or a nested multi-task machine learning model).

In some implementations, a shared backbone of the multi-task machine learning model extracts one or more features from the search result.

In some implementations, the first user task associated with the second objective depends on the first user task associated with the second objective. For example, a recipient user responding to a communication from a searcher user depends on the searcher user sending a communication to the recipient user. The recipient user responding to the communication is associated with the recipient objective (e.g., interacting with communications from the searcher user) and the searcher user sending the communication is associated with the searcher objective (e.g., communicating with recipient users related to a search query).

In some implementations, the machine learning model is trained end-to-end. For example, error is back propagated through one or more heads of the machine learning model.

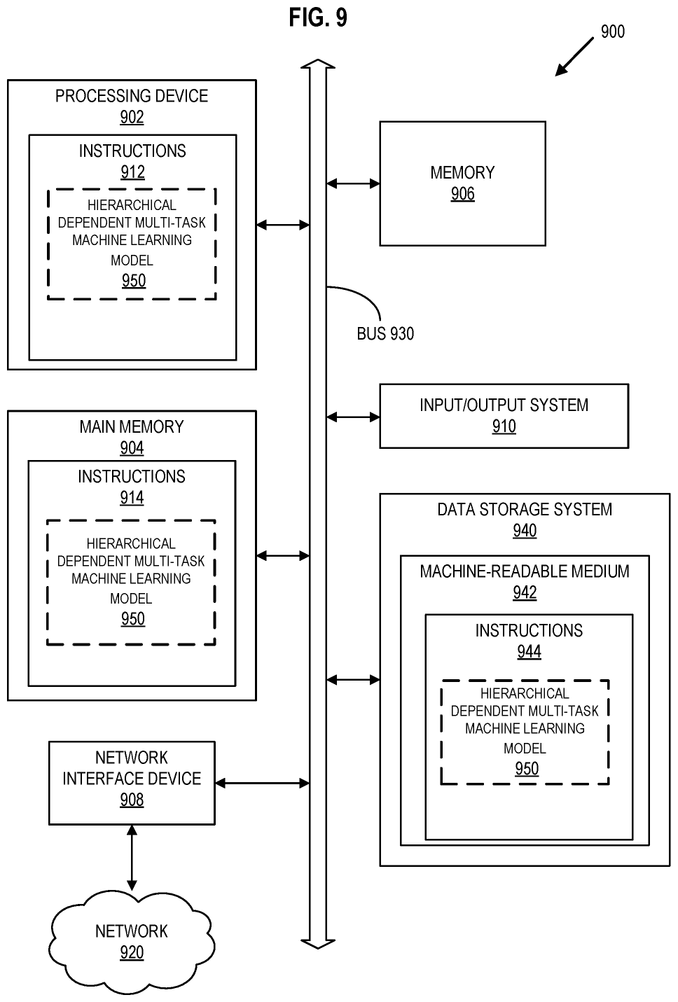

FIG. 9 is a block diagram of an example computer system including components of an application software system, in accordance with some embodiments of the present disclosure.

In FIG. 9, an example machine of a computer system 900 is shown, within which a set of instructions for causing the machine to perform any of the methodologies discussed herein can be executed. In some embodiments, the computer system 900 can correspond to a component of a networked computer system (e.g., as a component of the application software system 130 of FIG. 1 or the computer system 600 of FIG. 6) that includes, is coupled to, or utilizes a machine to execute an operating system to perform operations corresponding to one or more components of the hierarchical dependent multi-task machine learning model 150 and/or ranking system 120 of FIG. 1, or the hierarchical dependent multi-task machine learning model 650 of FIG. 6. For example, computer system 900 corresponds to a portion of computing system 600 when the computing system is executing a portion of the hierarchical dependent multi-task machine learning model 620 of FIG. 6.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 900 includes a processing device 902, a main memory 904 (e.g., read-only memory (ROM), flash memory, dynamic random access memory (DRAM) such as synchronous DRAM (SDRAM) or Rambus DRAM (RDRAM), etc.), a memory 903 (e.g., flash memory, static random access memory (SRAM), etc.), an input/output system 910, and a data storage system 940, which communicate with each other via a bus 930.

Processing device 902 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 902 can also be at least one special-purpose processing device such as an application specific integrated circuit (ASIC), a field programmable gate array (FPGA), a digital signal processor (DSP), network processor, or the like. The processing device 902 is configured to execute instructions 912 for performing the operations and steps discussed herein.

In some embodiments of FIG. 9, hierarchical dependent multi-task machine learning model 950 represents portions of hierarchical dependent multi-task machine learning model 950 when the computer system 900 is executing those portions of hierarchical dependent multi-task machine learning model 950. Instructions 912 include portions of hierarchical dependent multi-task machine learning model 950 when those portions of the hierarchical dependent multi-task machine learning model 950 are being executed by processing device 902. Thus, the hierarchical dependent multi-task machine learning model 950 is shown in dashed lines as part of instructions 912 to illustrate that, at times, portions of the hierarchical dependent multi-task machine learning model 950 are executed by processing device 902. For example, when at least some portion of the hierarchical dependent multi-task machine learning model 950 is embodied in instructions to cause processing device 902 to perform the method(s) described herein, some of those instructions can be read into processing device 902 (e.g., into an internal cache or other memory) from main memory 904 and/or data storage system 940. However, it is not required that all of the hierarchical dependent multi-task machine learning model 950 be included in instructions 912 at the same time and portions of the hierarchical dependent multi-task machine learning model 950 are stored in at least one other component of computer system 900 at other times, e.g., when at least one portion of the hierarchical dependent multi-task machine learning model 950 are not being executed by processing device 902.

The computer system 900 further includes a network interface device 908 to communicate over the network 920. Network interface device 908 provides a two-way data communication coupling to a network. For example, network interface device 908 can be an integrated-services digital network (ISDN) card, cable modem, satellite modem, or a modem to provide a data communication connection to a corresponding type of telephone line. As another example, network interface device 908 can be a local area network (LAN) card to provide a data communication connection to a compatible LAN. Wireless links can also be implemented. In any such implementation network interface device 908 can send and receives electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 900.

Computer system 900 can send messages and receive data, including program code, through the network(s) and network interface device 908. In the Internet example, a server can transmit a requested code for an application program through the Internet and network interface device 908. The received code can be executed by processing device 902 as it is received, and/or stored in data storage system 940, or other non-volatile storage for later execution.

The input/output system 910 includes an output device, such as a display, for example a liquid crystal display (LCD) or a touchscreen display, for displaying information to a computer user, or a speaker, a haptic device, or another form of output device. The input/output system 910 can include an input device, for example, alphanumeric keys and other keys configured for communicating information and command selections to processing device 902. An input device can, alternatively or in addition, include a cursor control, such as a mouse, a trackball, or cursor direction keys for communicating direction information and command selections to processing device 902 and for controlling cursor movement on a display. An input device can, alternatively or in addition, include a microphone, a sensor, or an array of sensors, for communicating sensed information to processing device 902. Sensed information can include voice commands, audio signals, geographic location information, haptic information, and/or digital imagery, for example.

The data storage system 940 includes a machine-readable storage medium 942 (also known as a computer-readable medium) on which is stored at least one set of instructions 944 or software embodying any of the methodologies or functions described herein. The instructions 944 can also reside, completely or at least partially, within the main memory 904 and/or within the processing device 902 during execution thereof by the computer system 900, the main memory 904 and the processing device 902 also constituting machine-readable storage media. In one embodiment, the instructions 944 include instructions to implement functionality corresponding to a hierarchical dependent multi-task machine learning model 950 (e.g., the hierarchical dependent multi-task machine learning model 150 and/or the ranking system 120 of FIG. 1 or the hierarchical dependent multi-task machine learning model 620 of FIG. 5).

Dashed lines are used in FIG. 9 to indicate that it is not required that the hierarchical dependent multi-task machine learning model 950 be embodied entirely in instructions 912, 914, and 944 at the same time. In one example, portions of the hierarchical dependent multi-task machine learning model 950 are embodied in instructions 914, which are read into main memory 904 as instructions 914, and portions of instructions 912 are read into processing device 902 as instructions 912 for execution. In another example, some portions of the hierarchical dependent multi-task machine learning model 950 are embodied in instructions 944 while other portions are embodied in instructions 914 and still other portions are embodied in instructions 912.

While the machine-readable storage medium 942 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 9 and the accompanying description, above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 600, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
configuring a memory according to a machine learning model, wherein the machine learning model comprises a shared backbone and a plurality of heads each trained to perform a task associated with either a first objective or a second objective, wherein:
an output of the shared backbone is input into:
a first head of the plurality of heads, wherein the first head is trained to perform a first task associated with the first objective,
a second head of the plurality of heads, wherein the second head is trained to perform a first task associated with the second objective,
a third head of the plurality of heads, wherein the third head is trained to perform a second task associated with the first objective, and
an output of the first head is input into the second head of the plurality of heads,
an output of the second head is input into a fourth head of the plurality of heads,
an output of the third head is input into the fourth head of the plurality of heads, and
an output of the fourth head of the plurality of heads, wherein the output is based on the first objective and the second objective.

2. The method of claim 1, wherein the first objective contradicts the second objective.

3. The method of claim 1, wherein the task performed by each head of the plurality of heads is a listwise ranking task.

4. The method of claim 1, wherein the second task associated with the first objective includes a plurality of sub-tasks.

5. The method of claim 4, wherein the third head is a nested multi-task machine learning model, and each head of the nested multi-task machine learning model performs a sub-task of the plurality of sub-tasks.

6. The method of claim 1, wherein the shared backbone is configured to extract one or more features from a search result.

7. The method of claim 1, wherein the first task associated with the second objective depends on the first task associated with the first objective.

8. The method of claim 1, wherein the machine learning model is trained end-to-end.

9. The method of claim 1, wherein the first head ranks a search result according to the first task associated with the first objective.

10. The method of claim 1, wherein the second head ranks a search result according to the first task associated with the second objective.

11. The method of claim 1, wherein the third head ranks head ranking a search result according to the second task associated with the first objective.

12. A system comprising:
at least one processor; and
at least one memory, wherein the at least one memory is configured according to a machine learning model comprising a shared backbone and a plurality of heads each trained to perform a task associated with either a first objective or a second objective, wherein the first objective contradicts the second objective, and wherein:
an output of the shared backbone is input into:
a first head of the plurality of heads, wherein the first head is trained to perform a first ranking task associated with the first objective,
a second head of the plurality of heads, wherein the second head is trained to perform a first ranking task associated with the second objective,
a third head of the plurality of heads, wherein the third head is trained to perform a second ranking task associated with the first objective, and
an output of the first head is input into the second head of the plurality of heads,
an output of the second head is input into a fourth head of the plurality of heads,
an output of the third head is input into the fourth head of the plurality of heads, and
an output of the fourth head of the plurality of heads ranks a search result according to the first objective and the second objective.

13. The system of claim 12, wherein the first ranking task associated with the first objective, the first ranking task associated with the second objective, and the second ranking task associated with the first objective are each listwise ranking tasks.

14. The system of claim 12, wherein the second ranking task associated with the first objective includes a plurality of sub-tasks.

15. The system of claim 14, wherein the third head is a nested multi-task machine learning model, and each head of the nested multi-task machine learning model performs a sub-task of the plurality of sub-tasks.

16. The system of claim 12, wherein the machine learning model is trained end-to-end.

17. A non-transitory computer-readable medium storing executable instructions, which when executed by a processing device, cause the processing device to perform operations comprising:
obtaining a search result including a plurality of entries associated with a search query;
inputting the search result into a machine learning model trained to rank the search result according to a first objective and a second objective, wherein the machine learning model comprises:
a shared backbone outputting a feature representation into:
a first head of a plurality of heads, wherein the first head is trained to perform a first task associated with the first objective,
a second head of the plurality of heads, wherein the second head is trained to perform a first task associated with the second objective,
a third head of the plurality of heads, wherein the third head is trained to perform a second task associated with the first objective, and
an output of the first head is input into the second head of the plurality of heads,
an output of the second head is input into a fourth head of the plurality of heads,
an output of the third head is input into the fourth head of the plurality of heads, and
an output of the fourth head of the plurality of heads ranks the search result.

18. The non-transitory computer-readable medium of claim 17, wherein the second task associated with the first objective includes a plurality of sub-tasks.

19. The non-transitory computer-readable medium of claim 18, wherein the third head is a nested multi-task machine learning model, and each head of the nested multi-task machine learning model performs a sub-task of the plurality of sub-tasks.

20. The non-transitory computer-readable medium of claim 17, wherein the machine learning model is trained end-to-end.
